(19) United States
(12) Patent Application Publication
(10) Pub. No.: US 2002/0029135 A1
(43) Pub. Date: Mar. 7, 2002

(54) Process for increasing the efficiency of a computer in finite element simulations and a computer for performing that process

(75) Inventors: Klaus Hollig, Zavelstein (DE); Ulrich Reif, Reichelsheim (DE); Joachim Wipper, Leinfelden-Echterdingon (DE)

Correspondence Address: ROYLANCE, ABRAMS, BERRO & GOODMAN, L.L.P., 1300 19TH STREET, N.W., SUITE 600, WASHINGTON,, DC, 20036, US

(73) Assignee: Universitaet Stuttgart

(21) Appl. No.: 09/853,026

(22) Filed: May 11, 2001

(30) Foreign Application Priority Data
May 12, 2000 (DE) 100 23 377.5

(51) Int. Cl. G06F 17/10

(52) U.S. Cl. 703/2

(57) ABSTRACT

The invention relates to a process for increasing the efficiency of a computer system in finite element simulations by efficient automatic construction of suitable basis functions for computing approximate solutions and one such computer system. In the process as claimed in the invention, a grid covering the simulation region is generated. B-splines defined thereon with supports, which intersect the simulation region, are classified into inner and outer B-splines (5). Then, coupling coefficients for forming linear combinations of inner and outer B-splines are determined (6), and the parameters which determine the resulting basis functions, are stored and output.

### FIELD OF THE INVENTION

The present invention relates to a process for increasing the efficiency of a computer in finite element simulations by efficient automatic construction of suitable basis functions for computation of approximate solutions, and to a computer for performing that process.

### BACKGROUND OF THE INVENTION

A plurality of technical and physical phenomena can be described by partial differential equations. They include among others problems from fluid mechanics (for example, flow around an airfoil), electromagnetic field theory (for example, electrical field behavior in a transistor) or elasticity theory (for example, deformation of a car body). Accurate knowledge and description of such processes are a central element in the construction and optimization of technical objects. To save time-consuming and cost-intensive experiments, there is great interest in computer-aided simulations. Finite element processes (FE processes) have become established and have been the topic of intense research for a long time. This also applies to automatic mesh generation processes as a foundation for construction of suitable basis functions.

FIG. 1 illustrates in the left half the prior art in the process of FE simulation for a linear boundary value problem as a typical model example. Proceeding from the data describing the geometry of the technical object to be simulated, first a system of basis functions is constructed which on the one hand enables fulfilment of boundary conditions and on the other is suited for approximation of the unknown solution. Then, using these basis functions a system of linear equations is set up by numerical integration methods. Finally, the coefficients of the unknown approximation are determined as the solution of this system of linear equations.

FE methods or their use are the subject matter of a series of patents. For example, U.S. Pat. No. 4,819,161 discloses a system where FE approximations of a large class of differential equations are automated. U.S. Pat. No. 5,731,817 discloses a process for generation of hexahedral meshes forming the foundation for a FE simulation process.

In most FE processes of practical relevance basis functions are used which are defined on a decomposition produced by generating a mesh of the simulation region. FIG. 2a shows a selection of conventional elements; their dimension, degree, smoothness and parameters are listed in FIG. 2b. A survey of meshing methods of planar regions can be found for example in K. Ho-Le, Finite Element Mesh Generation Methods: A review and classification. Com. Aided Design 20 (1988), 27-38. Generating a mesh for complicated three-dimensional regions is extremely difficult using the current state of knowledge, as shown by S. Owen, A survey of unstructured Mesh Generation Technology, Proceedings, 7th International Meshing Round Table, Sandia National Lab (1998), 239-257. The processes require extensive amounts of computer time and are to some extent not yet completely automated. But recently, there has been a series of very innovative new approaches. For example, A. Fuchs, Optimierte Delaunay-Triangulierungen zun Vernetzung getrimmter NURBS-Körper, University of Stuttgart, 1999, simulates a force distribution in order to achieve an optimum distribution of triangulation points. In U.S. Pat. No. 5,729,670 two- and three-dimensional meshes are produced by solving flow problems; this is an interesting reversal of the conventional FE mechanism. In addition, many algorithms have been developed to improve individual aspects of mesh generation processes. For example DE 196 21 434 A1 and U.S. Pat. No. 5,774,696 describe a process for elimination of intersections with prescribed edges or boundary surfaces in Delaunay triangulations.

Meshless FE-methods to date have not acquired any importance for applications. Both in the Lagrange multiplier method (see for example J. H. Bramble, The Lagrange Multiplier Method for Dirichlet's Problem, Math. Comp. 37 (1981), 1-11), and also in the penalty method (see for example P. Bochev and M. Gunzburger, Finite Element Methods of Least Squares Type, SIAM review 40 (1998), 789-837), the treatment of boundary conditions represents a major problem in the use of simple, stable basis functions.

In many technical simulations, automatic mesh generation is very complex and requires by far the largest part of the computer time. Furthermore, the approximation power of the conventionally used linear and multilinear basis functions is low. To achieve accurate results, a large number of basis functions must be used, and thus, a correspondingly large system of equations must be solved. Higher order trial functions on triangulations generally likewise have an unfavorable ratio between the attainable accuracy and the number of basis functions used. Finally, smooth basis functions cannot be easily defined on unstructured meshes. Very special constructions are necessary already for continuously differentiable elements (see FIG. 2a).

### SUMMARY OF THE INVENTION

The object of the present invention is to increase the efficiency of known FE methods and computers which carry out FE methods by efficient construction of basis functions with favorable properties. In particular the meshing of the simulation region will be completely eliminated, optional boundary conditions are fulfiled, accurate solutions are obtained with relatively few coefficients, and the resulting system of equations will be solvable efficiently. In this way the disadvantages of the prior art will be overcome, and thus, the accuracy and speed of the simulation of physical properties in the engineering and optimization of technical objects will be improved.

Some central terms and notations which are used in the following description of the process as claimed in the invention will be explained first.

The simulation region Ω is a bounded set of dimension d=2 or d=3 on which the physical quantities to be studied will be approximated by means of FE methods. The boundary of the simulation region is denoted by Γ. A grid with grid width h is defined as a decomposition of a subset of the plane or the space in grid cells Zₖ. Depending on the dimension d each grid cell is a square or a cube with edge length h. More precisely, Zₖⱼ=kh+[0, h]^{d}, wherein k belongs to a set of integer d-vectors. The uniform tensor product B-splines in d variables of degree n with grid width h are denoted by bₖⱼ, see for example O. de Boor, A Practical Guide to Splines, Springer, 1978. They are functions which can be continuously differentiated (n−1) times and which on the grid cells agree with polynomials of degree n, as shown in FIGS. 4a and 4b. FIG. 4a shows the support Qₖⱼ of the B-spline of degree n=2, dimension d=2 and smoothness m=1. In FIG. 4b, the resulting tensor product B-spline bₖ is shown. The support Qₖ, i.e. the union of all grid cells, on which the B-spline bₖ is not identical to zero, consists of (n+1)^{d} grid cells; more precisely, Qₖⱼ=kh+[0, (n+1)h]^{d}. In all figures, the B-spline bₖ is marked at the point kh, i.e. for example in the case d=2 at the lower left corner of the support. For FE simulations only those B-splines are important which have support intersecting the simulation region Ω; they are called relevant B-splines. The relevant B-splines are again divided into two groups; those B-splines for which the part of the support inside the simulation region is larger than a prescribed bound s are called inner B-splines. All other relevant B-splines are called outer B-splines.

The object of the present invention is achieved by the process defined in claim 1. Special embodiments of the invention are defined in the dependent claims. Claim 11 defines a computer system as claimed in the invention.

The right half of FIG. 1 shows the incorporation of the process of the present invention into the course of a FE simulation in the prior art and the substitution of certain process steps of a FE simulation in the prior art by the process of the present invention.

Input 1 of the simulation region Ω can be done via input devices, in particular also by storage of data derived from computer-aided engineering (CAD/CAM). For example, the data used in the engineering of a motor vehicle can be incorporated directly into the FE simulation in the present invention.

In input 2 and storage of the type of boundary conditions natural and essential boundary conditions are distinguished. The basis in the present invention is constructed for homogeneous boundary conditions of the same type. In particular, for essential boundary conditions, the basis functions vanish on the boundary Γ.

Inhomogeneous boundary conditions can be treated in the assembly of the FE systems using methods which correspond to the prior art.

Finally, the control parameters are read in 3. They relate to the degree n and the grid width h of the B-splines to be used and the bound s for classification of the inner and outer B-splines. If specifications are omitted, all these input parameters can be automatically determined by evaluation of merit functions which are constructed empirically or analytically.

The following construction of the basis functions of the invention is divided into the steps shown schematically in FIG. 3, which will now be described.

After reading in the simulation region Ω, in the first process step a grid covering the simulation region Ω is generated. Then it is checked which of the grid cells lie entirely inside, partially inside or not inside the simulation region Ω. The cell types 4 are determined, and this information about the cell types is stored. This essentially requires inside/outside tests and determinations of intersections between the boundary Γ of the simulation region Ω and the segments or squares which bound the grid cells. FIG. 7 shows the input and output data for this process step.

In the second process step, using the information about the cell types, the relevant B-splines are first determined. Then the classification 5 into outer B-splines is performed; the corresponding lists of indices are denoted by I and J. To this end, the size of those parts of the supports of the B-splines which lie within the simulation region is determined using the data obtained in the first process step, and compared with the prescribed bound s. FIG. 9 shows the input and output data for this process step.

In the third process step, coupling coefficients e_{i,j} are computed 6; they join the inner and outer B-splines according to the rule

$${B}_{i} ( x ) = {b}_{i} ( x ) + {\sum }_{j ∈ J ( i )} {e}_{i , j} {b}_{j} ( x ) , i ∈ I . \qquad ( 1 )$$

Hence, an extended B-spline Bᵢ is assigned to each inner B-spline Bᵢ. The construction and the properties of the index sets J(i) and the coupling coefficients e_{i,j} are given as follows. The index sets J(i) consist of indices of outer B-splines. They correspond to complementary index sets I(j) of indices of inner B-splines; i.e., i belongs to I(j) if and only if j belongs to J(i). For a given outer index j the index set I(j) is an array, i.e., a quadratic or cubical arrangement of (n+1)^{d} inner indices which is characterized by a minimum distance to the index j. For a given outer index j and an inner index i in the index set I(j), let pᵢ be the d-variate polynomial of degree n in each variable which has the value 1 at the point i and at all other points of the array I(j) the value 0. Then the coupling coefficient e_{i,j} is given as the value of pᵢ at the point j, i.e., e_{i,j}=pᵢ(j). The specific values of the coupling coefficient can either be tabulated for different degrees and relative positions of j and I(j) or can be easily computed using Lagrange polynomials. FIG. 11 shows the input and output data for this process step.

If natural boundary conditions are given, the extended splines defined in equation (1) are used without modification for further implementation of the FE process. If, on the other hand, essential boundary conditions are given, a weighting according to the rule

$${B}_{i} ( x ) ← \frac{w ( x )}{w ( {x}_{i} )} {B}_{i} ( x ) , i ∈ I \qquad ( 2 )$$

has to be performed. The pertinent interrogation takes place in an optional process step 6a. The functions defined in this way are called weighted extended B-splines (WEB-splines). Formally, the extended B-splines used under natural boundary conditions correspond to the special case w(x)=1. They are, therefore, also called WEB-splines. For the case of essential boundary conditions, the weight function w is characterized as follows: For all points x of the simulation region, w(x) can be bounded from above and below by positive constants, which are independent of x, times the distance dist(x) of the point x from the boundary Γ. In other words, w is positive within Ω and tends to zero in the vicinity of the boundary Γ as fast as the distance function dist. For simulation regions which are bounded by elementary geometrical objects (circles, planes, ellipses, etc.) a suitable weight function can optionally be given in explicit analytic form. Otherwise, computation rules should be used which typically represent a smoothing of the distance function. The scaling factor 1/w(xᵢ) is calculated by evaluating the weight function at the weight point xᵢ. This can be any point in the support of the B-spline bᵢ which is at least half the bound s/2 away from the boundary.

As a result of the process of the present invention, a computation rule for the WEB-splines Bᵢ (compare definitions (1) and (2)) is obtained which have all favorable properties according to the objectives of the invention. Thus the FE method can be continued according to the prior art. But, in doing so, it is possible to advantageously exploit the regular grid structure of the basis functions according to claim 11.

In summary, for the process of the present invention the coupling of outer and inner B-spline is, among other things, important. As a result, the constructed basis has the properties which are essential for FE computations. In particular, a basis Bᵢ (i from the index set I) according to the present invention, is stable, uniformly with respect to the grid width h, and the error has the same order as for the B-splines bₖⱼ in the approximation of smooth functions which satisfy the same boundary conditions. On the other hand, the fulfilment of essential boundary conditions is ensured by using the weight function w.

Other objects, advantages and salient features of the present invention will become apparent from the following detailed description which, taken in conjunction with the drawings, listed below, discloses preferred embodiments of the present invention. The features mentioned in the claims and in the specification can be essential to the invention individually or in any combination.

### BRIEF DESCRIPTION OF THE DRAWINGS

Referring to the drawings which form a part of this disclosure:

FIG. 1 is a flow chart of the individual steps of the prior art in the course of the finite element simulation and integrates the determination of the WEB basis into this process;

FIG. 2a compares certain finite elements of the prior art to the WEB element shown in FIG. 2b and lists the parameters relevant to finite element approximations;

FIG. 3 is a flow chart of the process steps for determining the WEB basis;

FIGS. 4a and 4b show a support and the corresponding tensor product B-spline of degree 2;

FIGS. 5a and 5b illustrates the problem formulation of the first embodiment (displacement of a membrane under constant pressure) and of the corresponding solution;

FIG. 6 shows the cell types for the first embodiment;

FIG. 7 surveys the input and output data of the process for determining the cell types;

FIG. 8 illustrates, by way of example, the classification of the B-splines for the first embodiment;

FIG. 9 outlines the input and output data of the process for classifying the B-splines;

FIG. 10 shows the coupling coefficients of an outer B-spline and the corresponding inner B-splines for the first embodiment;

FIG. 11 surveys the input and output data of the process for computing the coupling coefficients;

FIGS. 12a and 12b illustrates the construction of the weight function of the preferred embodiment;

FIG. 13 shows the support of a WEB-spline and the corresponding coupling coefficients for the first embodiment;

FIGS. 14a and 14b explains the problem formulation of a second embodiment (incompressible flow) and its solution using the flow lines and the distribution of the flow velocity;

FIGS. 15a to 15c show the changing classification of B-splines for the B-spline degrees n=1, 2, 3 and the same grid width for the second embodiment;

FIGS. 16a to 16c provide information about the error development in the finite element approximation using WEB-splines and about the computing time behavior of WEB approximations for the second embodiment;

FIGS. 17a and 17b compare the WEB basis to a process based on linear trial functions on a triangulation (prior art); and

FIG. 18 shows a computer system according to the present invention.

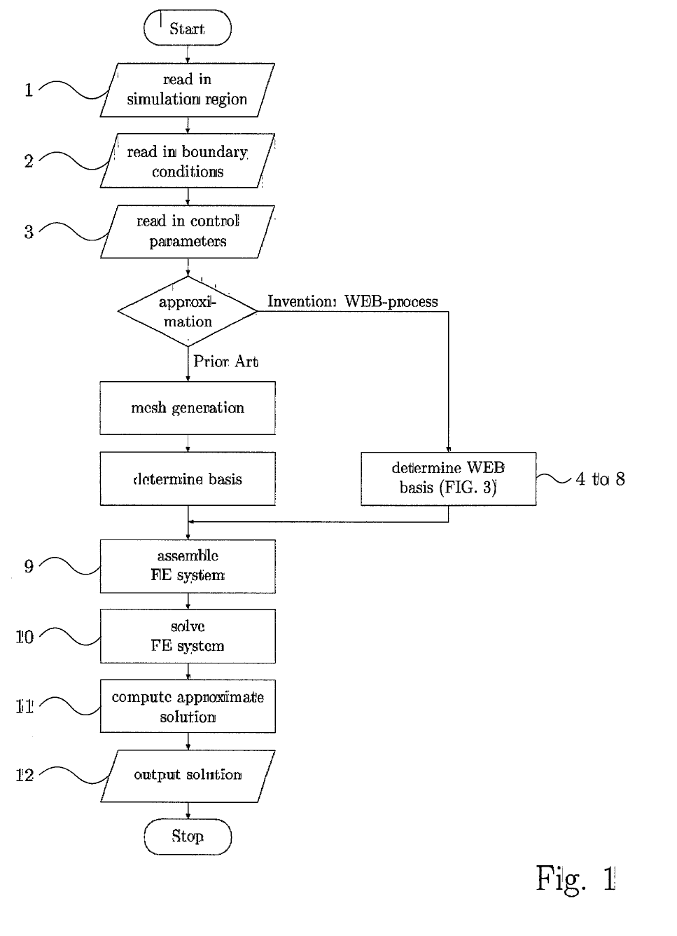

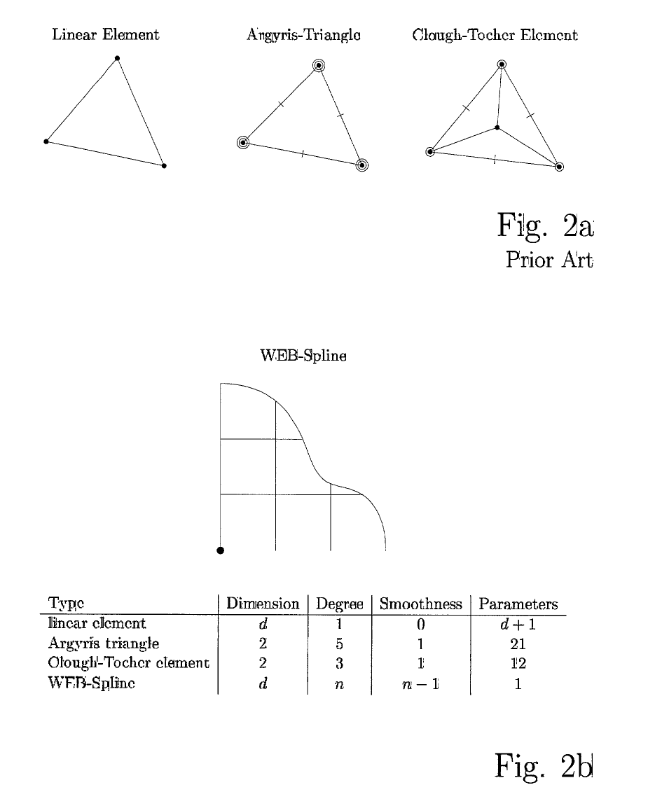

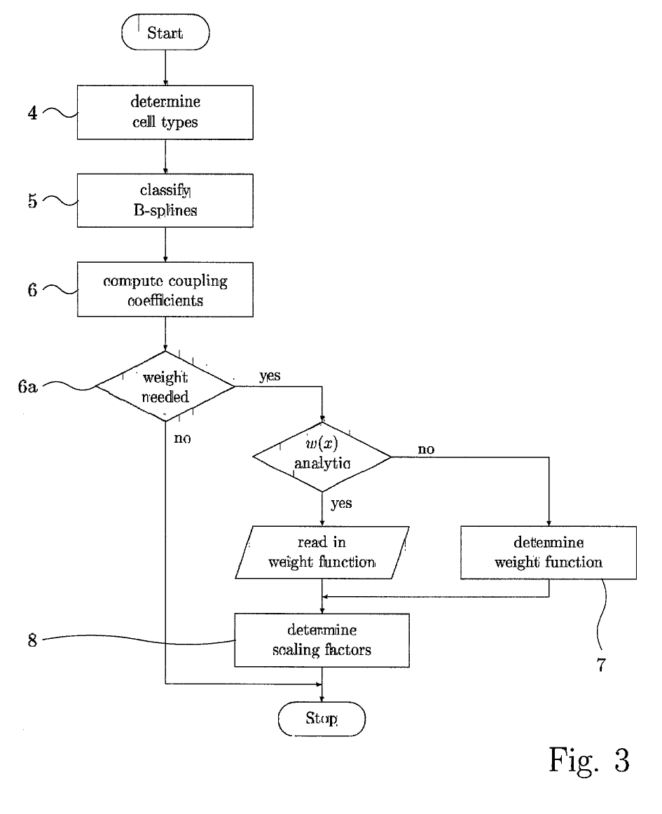

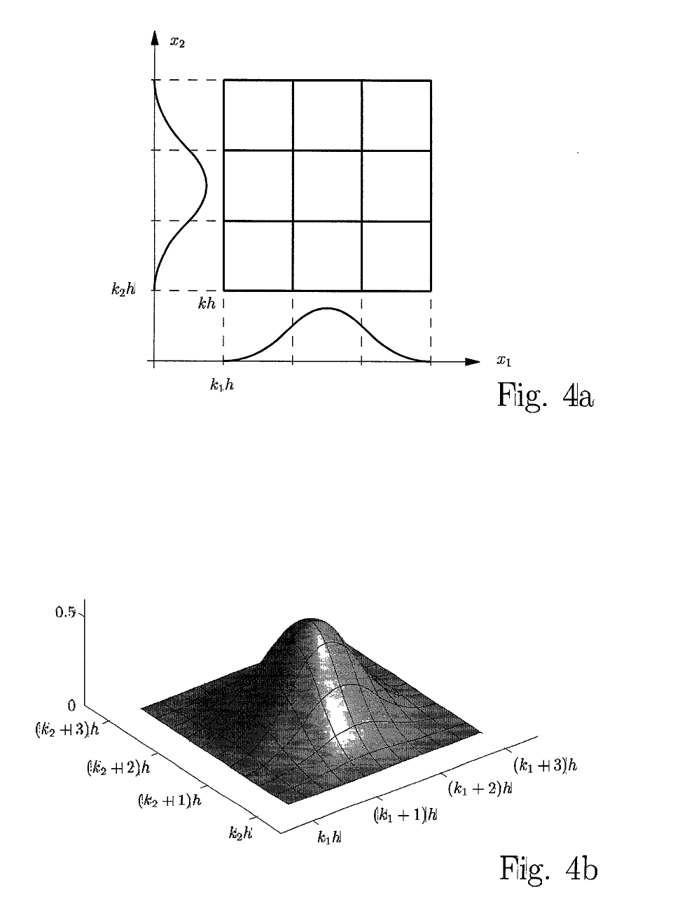

### DETAILED DESCRIPTION OF THE INVENTION

One especially favorable embodiment of the process of the present invention, called the WEB process, is determined by the following specifications.

The bound s is chosen such that the inner B-splines are characterized by requiring that at least one of the grid cells of their support lies completely in the simulation region Ω. Since to determine the relevant B-splines, the intersection of the grid cells and the boundary Γ must be computed anyway, the classification requires no significant additional computing time. The weight point xᵢ is chosen as the midpoint of a grid cell in the support of the B-spline bᵢ which lies completely in the simulation region Ω. This is also efficiently possible since the determination of one such cell is already part of the classification routine.

If no explicit analytic form of the weight function is known, it is defined by

$$w ( x ) = \{ \begin{matrix}1 & if dist ( x ) \geq δ \\ 1 - {( 1 - dist ( x ) / δ )}^{n} & if dist ( x ) < δ .\end{matrix} \qquad ( 3 )$$

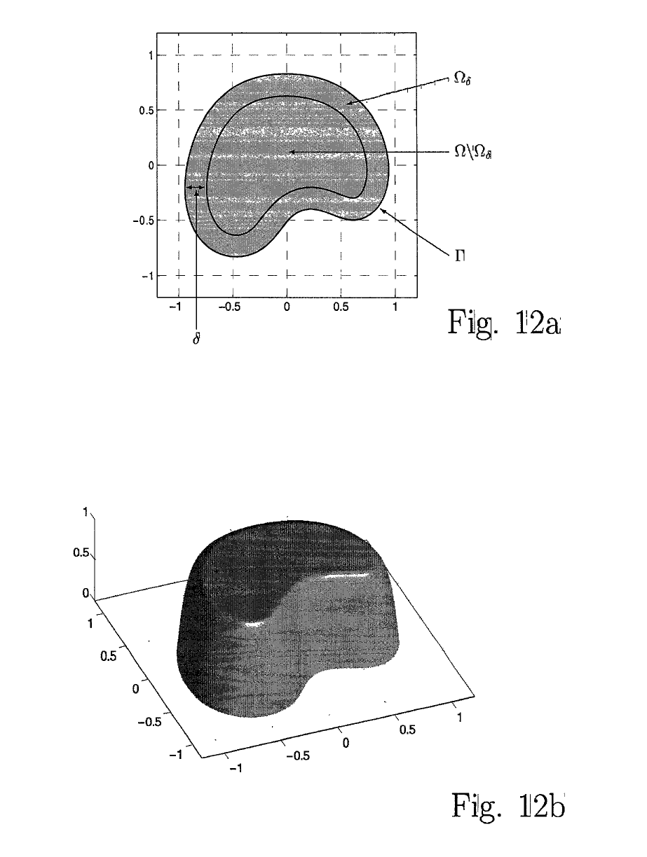

FIGS. 12a and 12b illustrate the construction of the weight function. Here, the parameter δ indicates the width of the strip Ω_{δ} within which the weight function varies between the value 0 of the boundary of the simulation region and the value 1 on the plateau on Ω\Ω_{δ}. The parameter δ is chosen such that the smoothness of the weight function is ensured.

One important advantage of the process is that no meshing of the simulation region is necessary. In technical applications, this results in clear savings of computing time and storage capacity and simplifies the course of the simulation. The process structure for two- and three-dimensional problems is formally and technically largely identical. This enables time- and cost-saving implementations of solutions for diverse applications based on uniform program structures. The use of B-splines corresponds to the industrial standard in the modeling of geometrical objects, and thus forms a natural connection between FE and CAD/CAM applications. Extensive existing program libraries from both fields can be used for implementing a FE simulation based on the process of the present invention. The basis functions constructed using the WEB process have all standard properties of finite elements. This includes especially the stability of the basis. It implies, for example, that for linear elliptic boundary value problems the condition number of the resulting system of equations does not grow faster than for optimal triangulations as the grid width becomes smaller. For applications, this means, for example, that linear systems of equations as they typically arise in FE methods, can be efficiently solved by iterative algorithms. Furthermore, for a given degree, the approximation order is maximal and the number of necessary parameters minimal. Thus, very accurate approximations are possible with a relatively small number of parameters. Specifically, this can mean that the accuracies which so far required the use of mainframe computers can now be achieved with workstations. The regular grid structure of the basis of the present invention permits a very efficient implementation, especially for assembling and solving FE systems. Moreover, by using the weight function, the boundary conditions can be satisfied during simulation without affecting the regular grid structure of the basis functions. Finally, by using multigrid methods to solve the linear systems arising in linear elliptic boundary value problems, one can achieve that the overall solution time is proportional to the number of unknown coefficients, and thus optimal.

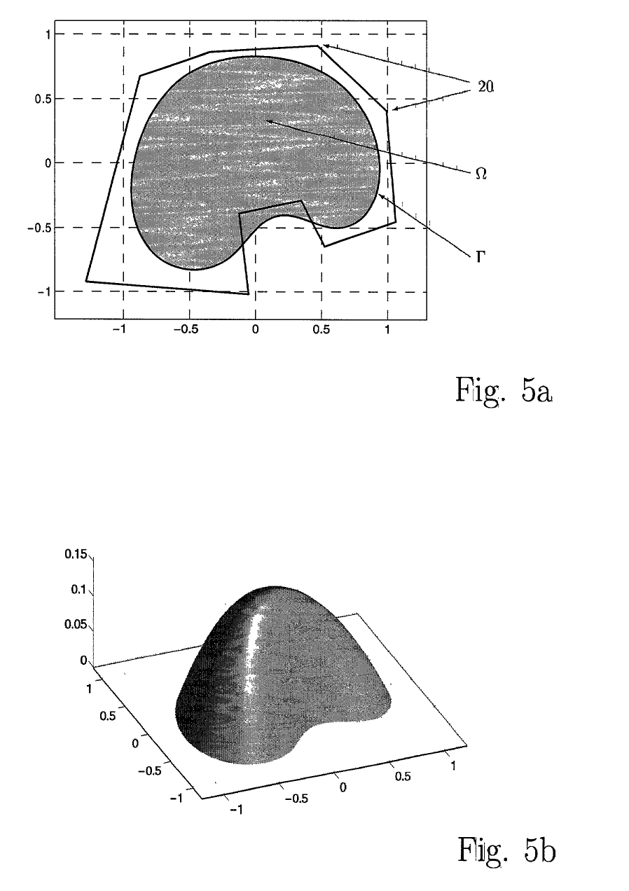

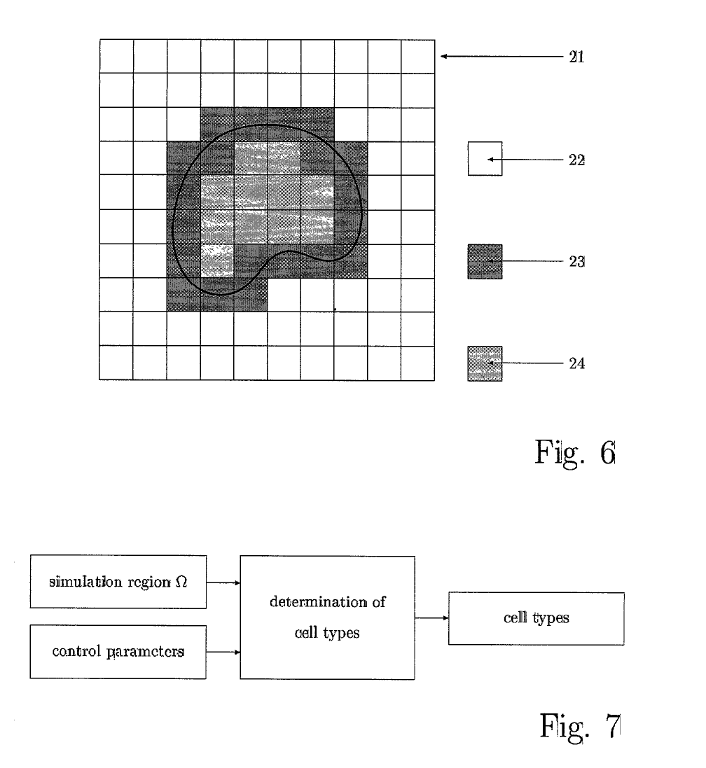

The process of the present invention in the special preferred embodiment (WEB process) is illustrated using the first embodiment shown in FIGS. 5a and 5b. The differential equation and boundary conditions are chosen to be very elementary so that in addition to the construction of the WEB basis of the present invention the entire course of the FE simulation can be followed without major additional effort.

FIG. 5a shows an elastic membrane which is fixed along the edge Γ of a planar simulation region Ω, and on which a constant pressure f=1 acts inside the region.

With suitable normalization, the displacement u satisfies the Poisson equation with homogeneous boundary conditions,

−Δu=1 in Ω

u=0 on Γ.

The displacement u or the deflection of the membrane is depicted in FIG. 5b. As described above, the WEB process is divided into the following steps.

Input 1 of the simulation region Ω. The boundary Γ is a periodic spline curve of degree 6, which is stored by its control points 20 (in FIG. 5a identified with black dots).

Input 2 of the boundary conditions: the homogeneous boundary condition is essential so that the construction of a weight function is necessary.

Input 3 of the control parameters: The degree n=2, and, in order to make the figures easier to understand, a relatively large grid width, h=1/3 are used.

Determination 4 of the cell types: As illustrated in FIG. 6, the simulation region is covered by a grid 21, which contains the grid cells of the supports of all B-splines of potential relevance for the basis construction. The type determination in the example yields 69 outer grid cells 22, and 11 inner grid cells 24, and 20 grid cells 23 on the boundary.

Classification 5 of the B-splines: Here, the support of the B-spline bₖ is a square Q|ₖⱼ with corners

(k₁, k₂)h, (k₁+3, k₂) h, (k₁+3, k₂+3)h, (k₁, k₂+3)h;

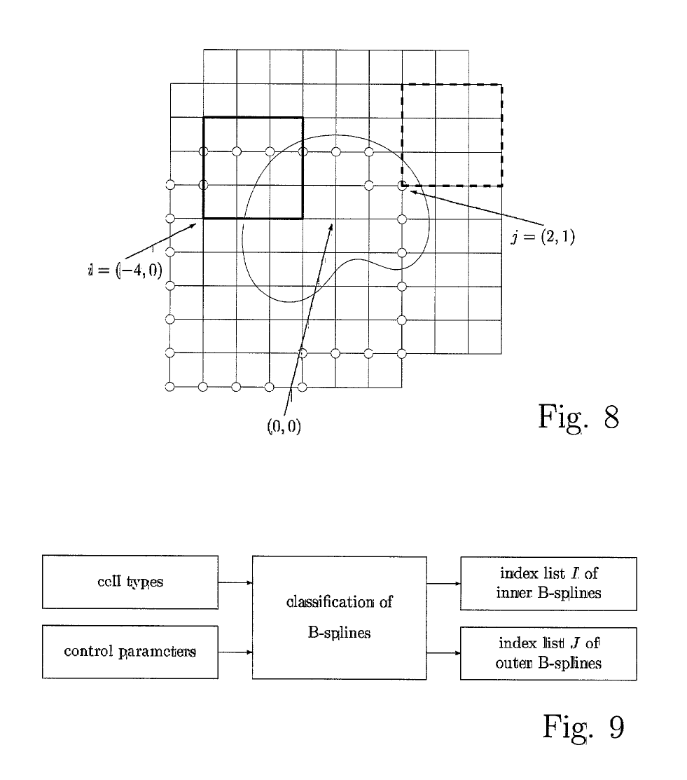

Q_{(-1,0)} and Q_{(2,1)} are shown in FIG. 8. The grid points kh of the relevant B-splines, for which Qₖⱼ intersects the interior of the simulation region, are marked in FIG. 8 by a point or a circle. All grid points ih for inner B-splines (i from the index list I), for which at least one cell of the support Qᵢ lies entirely within Ω, are marked by a point. For example, i=(−4,0), the grid cell (−2, 0)h+[0, h]² lies entirely in Ω. All grid points jh for outer B-splines (j from the index list J), for which no cell of the support Qⱼ lies entirely in Ω, are marked by a circle.

Computation 6 of the coupling coefficients: To determine the coupling coefficients e_{i,j} for each fixed j of the index list J the nearest 3×3-array

I(j)={l₁, l₁+1, l₁+2}×{l₂, l₂+1, l₂+2}

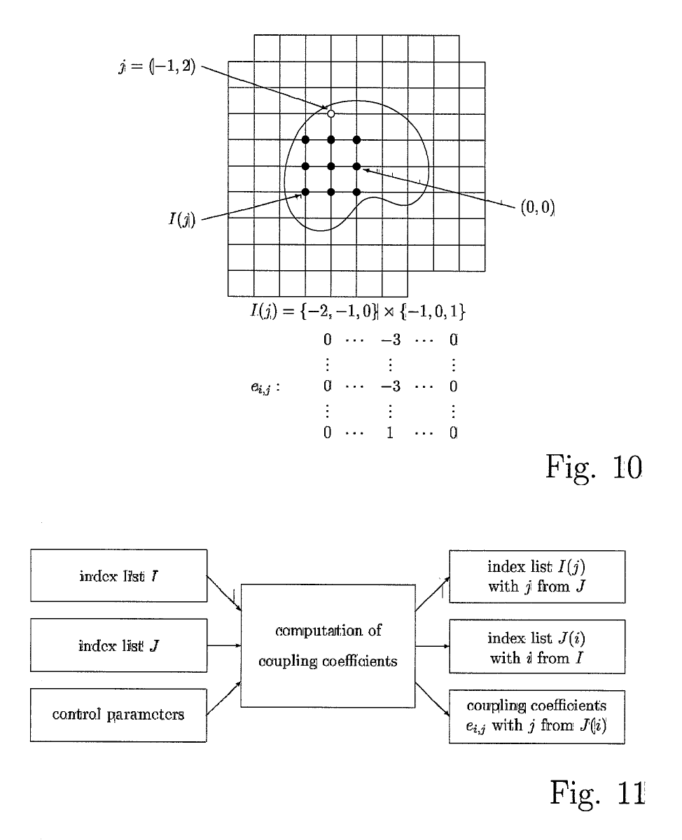

of indices in I is sought. In FIG. 10, for the outer grid point j=(−1, 2), which is marked with a circle, the array I(j) is identified with points. FIG. 10 likewise shows the corresponding coupling coefficients in a matrix representation. They are computed by bivariate interpolation. For example, the interpolating polynomial for i=(−1, −1) is

pᵢ(x)=−x₁(x₁+2)x₂(x₂−1)/2.

Its value it the point x=j=(−1, 2) is pᵢ(j)=1=eᵢⱼ. One notices that many of the coupling coefficients are 0. This is a typical phenomenon. The coupling coefficients e_{i,j} are not equal to 0 for all i of the index list I(j) only if the indices i are different from the index j in each component.

Computation rule 7 for the weight function: The weight function is given by equation (3) with n=2 and δ=0.2. The parameter δ is computed numerically. It must be small enough to prevent singularities of the distance function. To compute the distance function, the process generates a program which uses Newton's method. Since the weight function is not equal to 1 only in a boundary strip, the complexity in the subsequent evaluations is low.

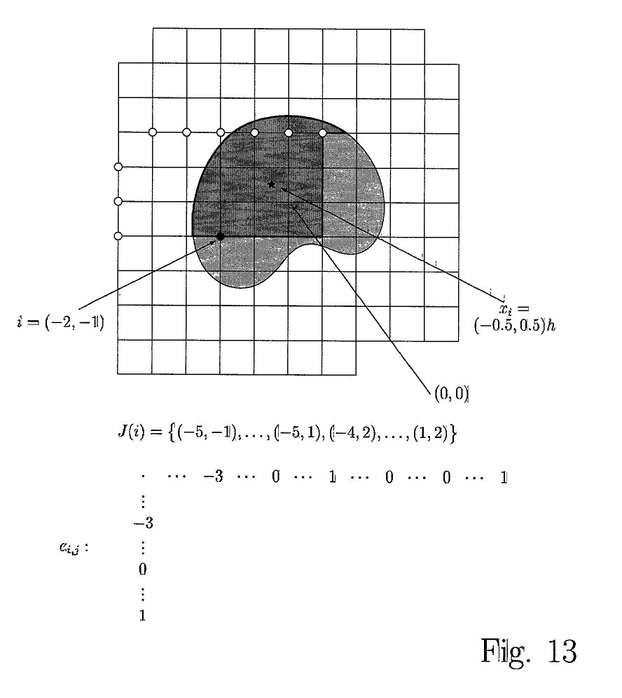

Output: FIG. 13 shows the support of a WEB-spline Bᵢ and the data necessary for its description. These are the index list J(i) of the outer B-splines bⱼ coupled with bᵢ, the coupling coefficients c_{i,j}, and the weight point xᵢ. These data are used in conjunction with the weight function for generating the computation rule for the WEB-splines.

The further course of the FE simulation follows the prior art.

Assembly 9 of the FE system: The entries of the system matrix and of the right-hand side are

G_{k,i}=∫_{Ω} grad Bₖ grad Bᵢ, Fₖ=∫_{Ω ƒB}ₖ, k, ε I.

The system of equations GC=F for the basis coefficients Cᵢ in this example has dimension 31. The matrix entries G_{i,j} are computed using numerical integration, likewise the integrals Fₖ.

Solution 10 of the FE system: The Galerkin system is solved iteratively with the conjugate gradient method with SSOR preconditioning used to accelerate convergence. After 24 iteration steps the solution is found within machine accuracy (tolerance ≦1e-14).

Computation 11 and output 12 of the approximation: The approximation computed with the process as claimed in the invention is u=ΣᵢCᵢBᵢ and is shown graphically in FIG. 5b. The relative error of the L₂-norm is 0.028.

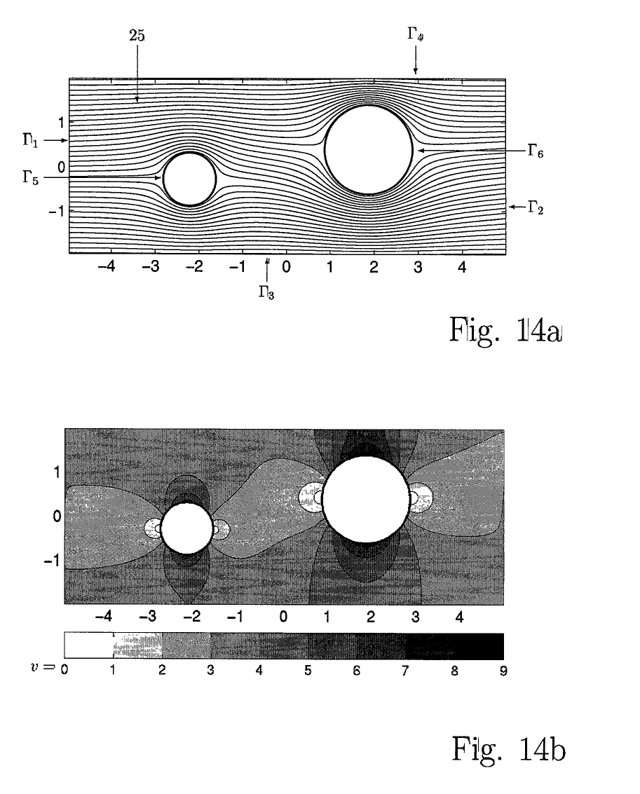

The efficiency of the process of the present invention in the special preferred embodiment (WEB process) is illustrated in a second embodiment using the simulation of an incompressible flow. The arrangement of two circular obstacles shown in FIG. 14a in a channel with parallel boundaries serves to illustrate the principal strategy. For complicated geometries, as are typically present in specific applications, the process works completely analogously and efficiently. In FIG. 14a the stream lines 25 are shown within the region bounded by Γ₁ to Γ₄; and by Γ₅ and Γ₆. The differential equation is:

Δu−0 in Ω

with the boundary conditions

$$\frac{\partial u}{\partial n} = {v}_{0} on {Γ}_{1} , \\ \frac{\partial u}{\partial n} = - {v}_{0} on {Γ}_{2} , \\ \frac{\partial u}{\partial n} = 0 on {Γ}_{3} , … , {Γ}_{6} .$$

The flow velocity v=−grad u is shown in the bottom half of the figure.

The construction of the WEB basis of the present invention proceeds completely analogously to the first embodiment. The sole difference is that a weight function is not necessary because of the natural boundary conditions.

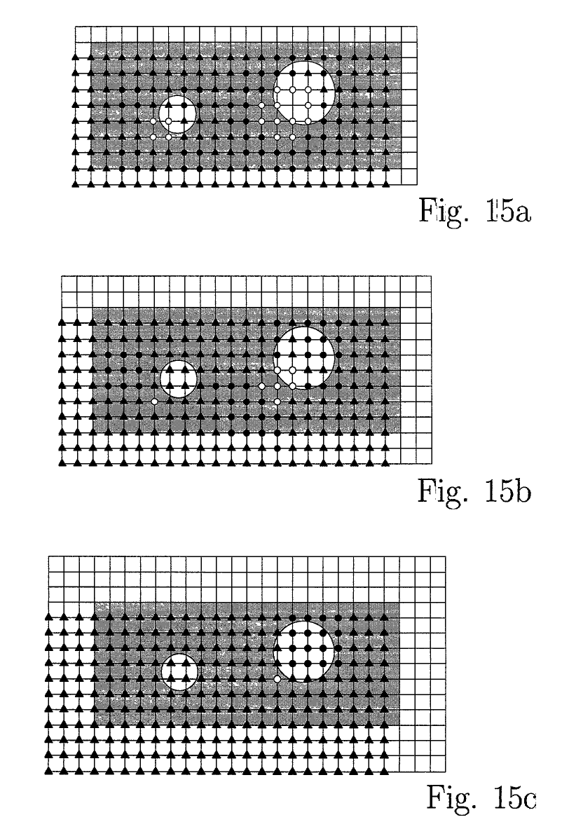

FIGS. 15a to 15c show the classification of the relevant B-splines for different degrees n (see also FIG. 8). In the figure, the inner B-splines bᵢ, which are taken into the WEB basis without extension, are marked by solid triangles. For small h the number of those B-splines increases, i.e., Bᵢ=bᵢ for most of the WEB basis. For degree n=3 this is the case for 236 of 252 indices in the example.

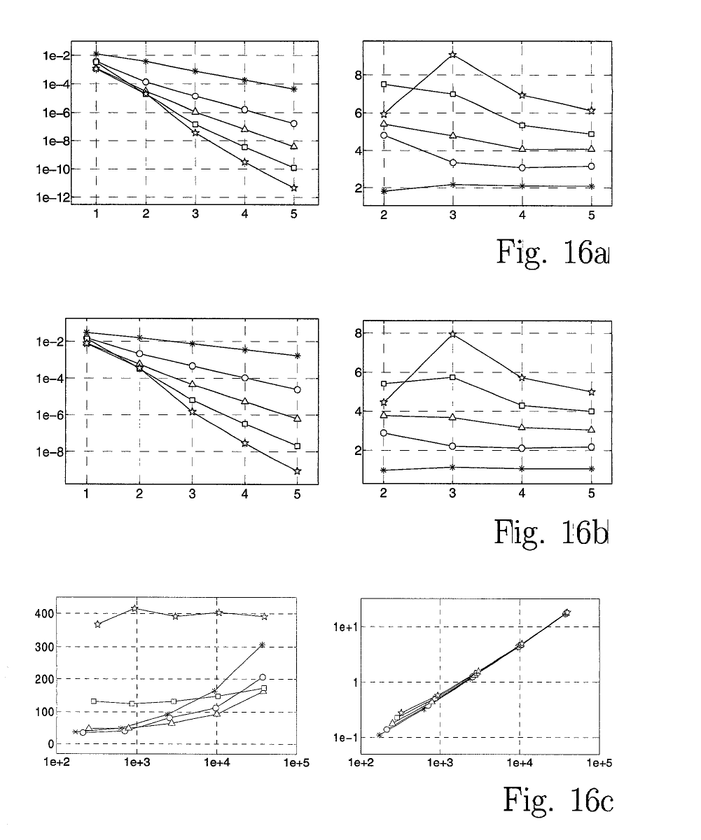

FIG. 16a shows in two diagrams the numerically determined relative L₂-error of the potential (left half of the figure) as a function of the grid width h=2^{-k} with k=1, . . . , 5 and the numerically estimated order of convergence m (right half of the figure). Here, for different degrees of the WEB-spline the following markers are used: * (n=1), ∘ (n=2), Δ(n=3), □ (n=4) and ☆ (n=5). As expected, m≈n+1, i.e., an approximate error reduction by a factor 2ⁿ⁺¹ when the grid width is cut in half. Analogously, for the relative approximately error of the flow velocity shown in FIG. 16b (H¹-norm of the solution, left half of the figure), an order of convergence m≈n (right half of figure) is obtained with an associated error reduction by roughly a factor 2ⁿ when the grid width is out in half.

FIG. 16c (right half of the figure) shows the computing time in seconds for construction of the WEB basis as a function of the number of resulting basis functions, measured on a Pentium II processor with 400 MHz. For example, for construction of a WEB basis of degree 3 with grid width h=0.125 with 2726 WEB-splines 1.32 seconds are necessary. One notices that the complexity for generating the WEB basis is largely independent of the degree n of the basis. In the left half of FIG. 16c the number of OG-iterations relative to the number of basis functions is shown. Thus, for the corresponding system with 2726 unknowns, 65 POG-iterations are required. The total computing time including assembling and solving the Galerkin system is roughly 2.48 seconds.

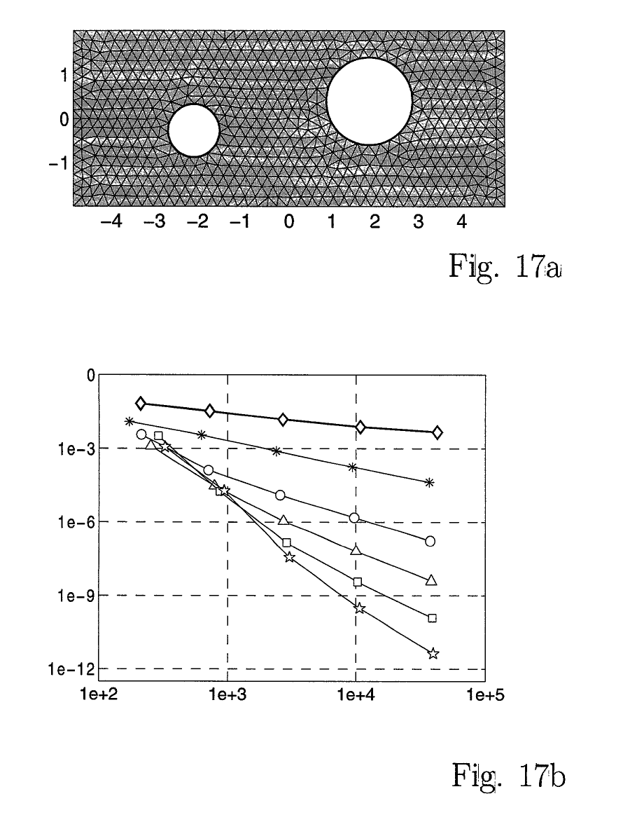

FIGS. 17a and 17b compare the WEB process with a standard solution process which meshes or triangulates the simulation region (FIG. 17a) and uses hat functions. The graph shows in FIG. 17b the L₂-error relative to the number of parameters. The results of the standard solver are marked with boldfaced diamonds and are compared to the results achieved using the WEB basis of degrees 1 to 5. For example, an accuracy of 10⁻² is achieved with the WEB process by using 213 basis functions with degree 2 and an overall computer time of 0.6 seconds. To achieve the same accuracy, the standard method with linear hat functions required 6657 basis functions.

In the assessment of the standard solution process two other aspects must be considered. On the other hand, FIG. 17b illustrates that even a moderate accuracy of 10⁻³ can only be achieved with hat functions when far more than one million coefficients are used. This shows that when using hat functions accurate results generally require an enormous computing and storage capacity or cannot be achieved at all with the prior art. On the other hand, the complexity required for meshing increases with the complexity of the simulation region. In contrast to realistic applications, the region studied here is comparatively simple to triangulate due to its simple structure.

The two-dimensional example shows the performance gain by the WEB process.

An even greater increase in performance is possible in three-dimensional problems. On the one hand, the complexity for meshing, which is eliminated in the WEB process, is much greater. On the other hand, the reduction in the number of required basis functions becomes much more noticeable than in the two-dimensional case.

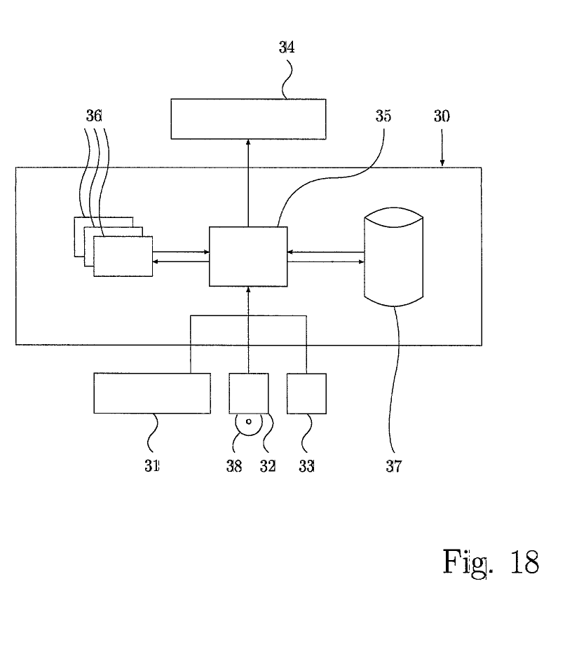

FIG. 18 shows a device according to the present invention, especially a computer system 30, with input devices 31, 32, 33, output devices 34 and a control unit 35 which controls the course of the process. To carry out the process of the present invention and in particular for purposes of parallelization of the pertinent computations, the central control unit 35 preferably uses several arithmetic logic units (ALU) or even several central processing units (CPU) 36. These allow especially parallel processing for the process steps classification 5 of the B-splines, in particular also intersection of the regular grid with the simulation region Ω, determination 6 of the coupling coefficients e_{i,j}, and/or evaluation of the weight function w(x) at points x of the simulation region Ω.

The computer units 36 here access the common data resources of the storage unit 37. The data can be input, for example, by a keyboard 31, a machine-readable data medium 38 via a corresponding read station 32 and/or via a wire or wireless data network with a receiver station 33. Via the read station 32 or a pertinent data medium 38, the control program, which controls the process execution, can be input, and, for example, can be permanently filed on the storage media 37. Accordingly, the output devices 34 can be a printer, a monitor, a write station for a machine-readable data medium and/or the transmitting station of a wire or wireless data network.

While various embodiments have been chosen to illustrate the invention, it will be understood by those skilled in the art that various changes and modifications can be made therein without departing from the scope of the invention as defined in

### LIST OF DESIGNATIONS AND ABBREVIATIONS

Bᵢ (weighted) extended B-splines (WEB-splines)

bᵢ inner B-splines

bⱼ outer B-splines

bₖ relevant B-splines

d dimension of B-Splines

dist distance function

dist(x) distance of point x from boundary Γ

c_{i,j} coupling coefficients

ƒ perturbation function (right hand side of the differential equation)

FE Finite Element

h grid width, edge length

I index set of the inner splines

I(j) index set of the inner splines coupled to an outer spline

i index of an inner spline

J index set of the outer splines

J(i) index set of the outer splines coupled to an inner spline

j index of an outer spline

k d-dimensional grid index

m order of convergence

n degree of B-splines

pᵢ d-variate polynomial of degree n

Qₖⱼ support of B-spline with index k

s bound of the support portion in Ω

u solution of the differential equation

v flow velocity

w(x) weight function

WEB weighted extended B-spline

xᵢ weight point in the simulation region

Zₖ grid cells

δ parameter, the width of the strip in which the weight function rises

Γ boundary of the simulation region

Ω simulation region

1 definition of the simulation region

2 input and storage of boundary conditions

3 establishment of control parameters

4 determination of a grid and cell classification

5 classification of the B-splines

6 determination of the coupling coefficients

7 determination of a weight function

8 determination of weight points and scaling factors

9 assembling of a system of equations

10 solution of the system of equations

11 computation of an approximate solution

12 output of the approximate solution

20 control points

21 grid

22 outer grid cells

23 grid cells on the boundary

24 inner grid cells

25 stream lines

30 computer means

31 keyboard

32 read station

33 receiving station

34 output means

35 central control means

36 computer unit

37 storage means

38 data medium

1. A process for increasing the efficiently of a computer for finite element simulations by automatic generation of suitable basis functions using B-splines, with the following steps:
definition (1) of a simulation region (Ω) and storage of the data of the simulation region (Ω);
input (2) and storage of boundary conditions;
establishment (3) of a predefinable grid width h and a predefinable degree n of the B-splines;
determination of a grid covering the simulation region (Ω) and the type of the grid cells;
classification (5) of the B-splines with support intersecting the simulation region by determining inner and outer B-splines, where for outer B-splines the intersection of the support with the simulation region is less than a predefinable bound s;
determination (6) of coupling coefficients e_{i,j} for formation of linear combinations of inner and outer B-splines; and,
a storage and output of the parameters which determine the basis functions.

2. Process as claimed in claim 1, wherein, before storage and output of the parameters, the following step is carried out: Establishing (7) a predefinable weight function w and determining the weight points and scaling factors.

3. Process as claimed in claim 2, wherein the weight function w is established by a smooth transition from a constant plateau inside the simulation region (Ω) to the value 0 on the boundary (Γ).

4. Process as claimed in one of the claims 1 to 3, wherein the B-splines with at least one grid cell of the support contained entirely in the simulation region (Ω) are classified as inner B-splines.

5. Process as claimed in one of the claims 1 to 4, wherein the weight point is chosen as the midpoint of a grid cell of the support of the corresponding B-spline, which is contained entirely in the simulation region.

6. Process as claimed in one of the claims 1 to 5, wherein the simulation region (Ω) is defined by storage of data which can be derived from computer-aided engineering (CAD/CAM).

7. Process as claimed in one the claims 1 to 6, wherein the grid width h is automatically established using stored values obtained empirically and/or analytically by a pertinent first evaluation function.

8. Process as claimed in one of the claims 1 to 7, wherein a degree n is automatically determined using stored values obtained empirically and/or analytically by a pertinent second evaluation function.

9. Process as claimed in one of the steps 1 to 8, characterized by the following steps.
assembling (9) a system of equations to be solved in a FE simulation:
a solving (10) the system of equations;
computing (11) an; approximate solution; and
output (12) of the approximate solution.

10. Process as claimed in claim 9, wherein a multigrid process is used for the solution (10) of the system of equations.

11. Device for executing a process as claimed in one of the claims 11 to 10, in particular a computer system, with input devices (31, 32, 33) and output devices (34), storage devices (37), and a central processing unit (35, 36), where the regular grid structure is utilized for optimizing the computational process, especially by parallelization.

12. Machine-readable data medium (18), in particular magnetic tape, magnetic disk, compact disk (CD) or digital versatile disk (DVD), wherein the data medium stores a control program for a computer system (30), according to which the computer system (30) can execute a process, as claimed in one of the claims 1 to 10.
